(19) United States
(12) Patent Application Publication
(10) Pub. No.: US 2016/0292117 A1
(43) Pub. Date: Oct. 6, 2016

(54) Methods and Apparatus for Efficient Network Analytics and Computing Card

(71) Applicant: Integrated Device Technology, Inc., San Jose, CA (US)

(72) Inventor: Mohammad Shahanshah Akhter, Ottawa (CA)

(21) Appl. No.: 14/673,818

(22) Filed: Mar. 30, 2015

(51) Int. Cl. G06F 13/40; G06F 13/42

(52) U.S. Cl. CPC G06F 13/4068; G06F 13/4221; G06F 13/4022

(57) ABSTRACT

Methods and Apparatus for Efficient Network Analytics and Computing Card have been disclosed. In one implementation a plurality of cards each having one or more GPU+CPU are interconnected via RapidIO.

### RELATED APPLICATION

The present Application for patent is related to U.S. patent application Ser. No. ______ titled “Methods and Apparatus for IO, Processing and Memory Bandwidth Optimization for Analytics Systems” filed Mar. 30, 2015 pending by the same inventor which is hereby incorporated herein by reference.

### FIELD OF THE INVENTION

The present invention pertains to a computing card. More particularly, the present invention relates to Methods and Apparatus for Efficient Network Analytics and Computing Card.

### BACKGROUND OF THE INVENTION

In a current network interface card, a PCIe-to-Ethernet or a PCIe-to-Infiniband or both may be used for interfacing. A current network interface card may include a RapidIO switch and a PCIe to RapidIO NIC device. Such an approach allows network expansion but does not provide any computation capability and therefore, needs to rely on server computation capability.

If a GPU computation is needed, a GPU card with PCIe interface may be used with a traditional server. Current GPU cards incorporate one or two GPUs as a dual GPU card. Such an approach does not allow scalable computation based on GPU while maintaining low latency between computing nodes due to limitations (such as but not limited to IO bandwidth) with the link between the GPU and Host CPU over PCIe.

FIG. 1 shows, generally at 100, a current NIC card 102 which incorporates a PCIe-Ethernet device 104. FIG. 2 shows, generally at 200, a current NIC card 202 which incorporates PCIe-RapidIO 204 devices and a RapidIO Switch device 206.

This presents a technical problem for which a technical solution using a technical means is needed.

### BRIEF DESCRIPTION OF THE DRAWINGS

The invention is illustrated by way of example and not limitation in the figures of the accompanying drawings.

FIG. 1 shows a current NIC card which incorporates a PCIe-Ethernet device.

FIG. 2 shows a current NIC card which incorporates PCIe-RapidIO devices and a RapidIO Switch device.

FIG. 3, FIG. 4, and FIG. 5 illustrate various embodiments of the invention showing a PCIe card with multiple GPU+CPU micro-modules mounted on a Network Analytics and Computing Card.

FIG. 6 shows one embodiment of the invention showing a PCIe card with a SATA interface, a PCIe host interface, an Ethernet interface, and a RapidIO interface.

FIG. 7 shows one embodiment of the invention showing a PCIe card with on-board storage, a PCIe host interface, an Ethernet interface, and a RapidIO interface.

FIG. 8, FIG. 9, FIG. 10, FIG. 11, and FIG. 12 each illustrate an embodiment of the invention showing a Network Analytics and Computing Card.

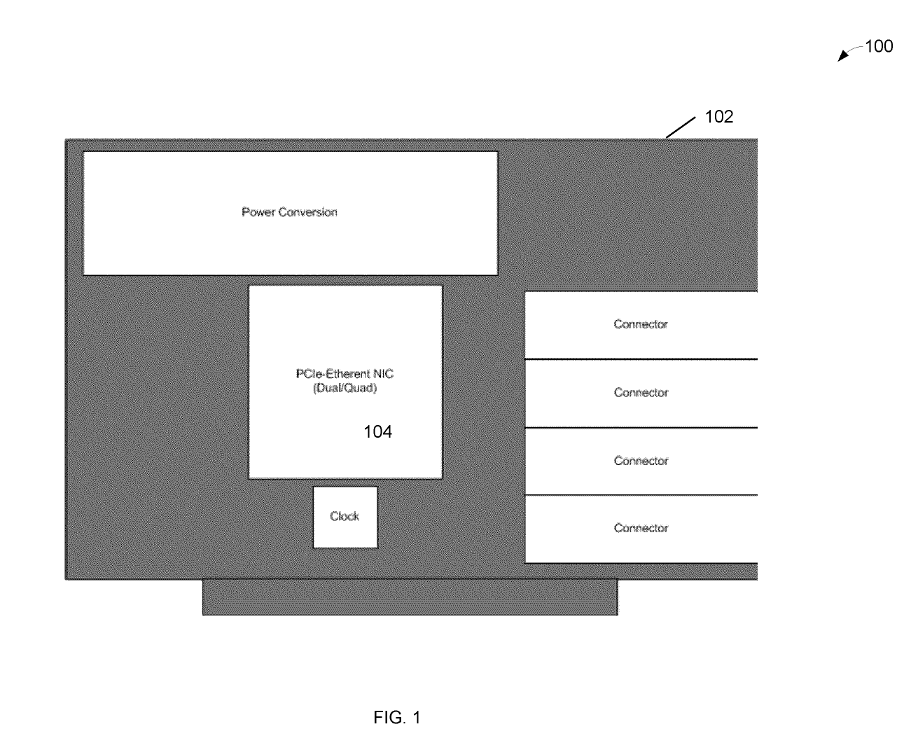

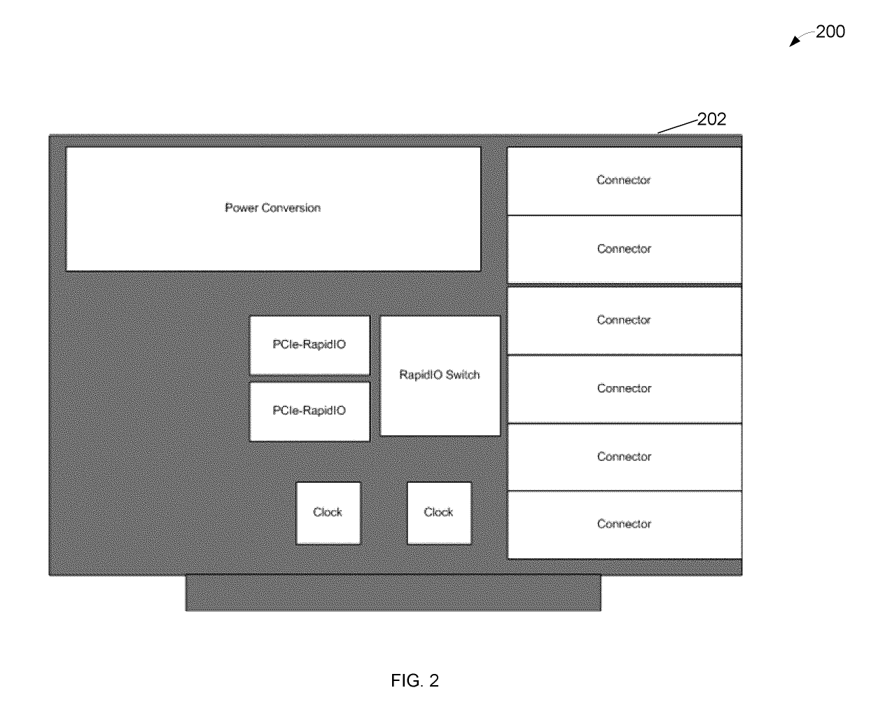

### DETAILED DESCRIPTION

In one embodiment the invention provides a high density modular (via micro-modules) scalable PCIe card for network and data analytics based on a GPU (Graphics Processing Unit) with an integrated CPU (Central Processor Unit).

In one embodiment the invention works with any standard server (e.g. via a standard interface, such as but not limited to, PCIe).

In one embodiment of the invention it is possible to scale-out to a large number of nodes with low latency (e.g. via a high speed low latency interface, such as but not limited to, RapidIO).

In one embodiment of the invention the architecture is directly applicable to data analytics and IoT (Internet Of Things).

In one embodiment the invention allows for scalable computation with a GPU off-load while balancing cost, power, and IO bandwidth with the GPU bandwidth.

In one embodiment the invention integrates a GPU+CPU (computation unit) with storage, and interconnects in a modular fashion to a PCIe card that can be used with any server with a PCIe slot.

In one embodiment of the invention the computation unit is designed as a module which can be plugged into the PCIe card.

In one embodiment of the invention to increase density the compute cards are connected at an angle while keeping sufficient spacing between the cards for cooling, etc.

In one embodiment the invention utilizes multiple GPUs with an integrated host processor.

In one embodiment of the invention multiple GPUs are connected via a RapidIO low latency interconnect.

In one embodiment the invention utilizes PCIe-RapidIO NICs (network interface controllers) to maximize bandwidth utilization per GPU using a ×4 PCIe port on the GPU.

In one embodiment of the invention a RapidIO fabric enables communication between GPUs in other modules leading to a scalable solution.

In one embodiment of the invention the RapidIO fabric together with the PCIe-RapidIO NIC allows a highly scalable multi-root solution.

In one embodiment the invention provides a high density scalable computation, analytics and storage card.

In one embodiment the invention provides a fault-tolerant and modular system.

In one embodiment of the invention it is easy to replace and upgrade the compute/GPU+CPU module.

In one embodiment the invention incorporates one or more micro-CPU+GPU modules with memory and storage.

In one embodiment of the invention the micro-modules are similar to a DIMM (Dual Inline Memory Module) module.

In one embodiment of the invention the micro-modules may be connected on a PCIe full-height full-width card with an angled connector.

In one embodiment of the invention the PCIe card incorporates low latency switching and network connectivity.

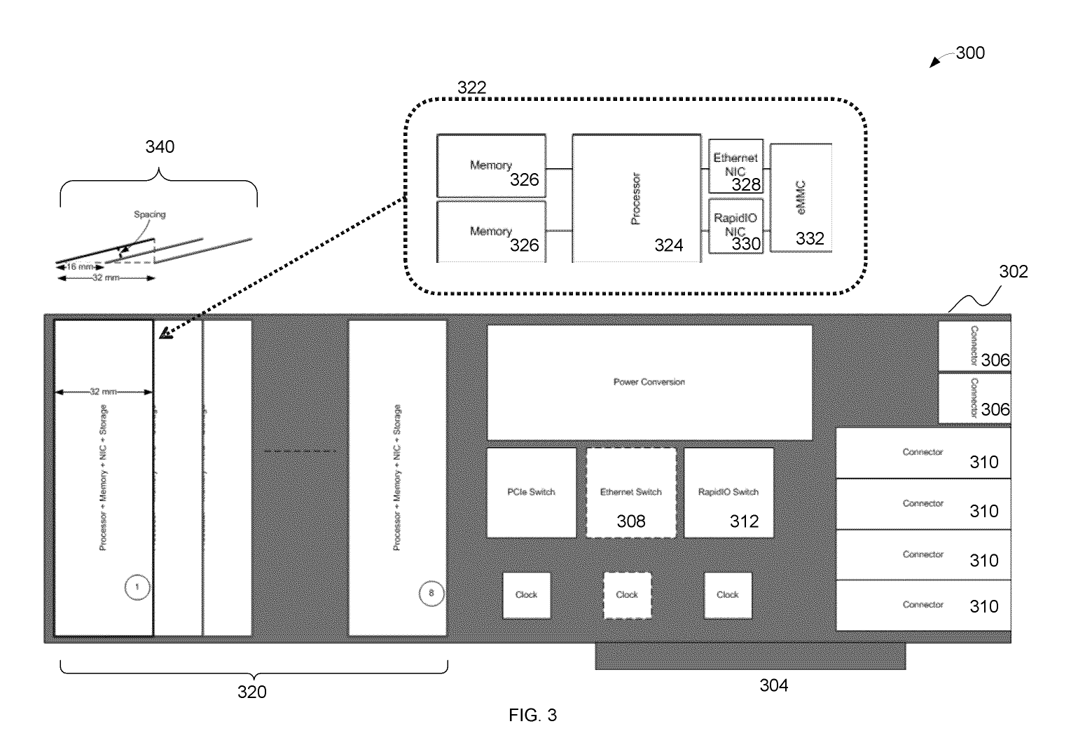

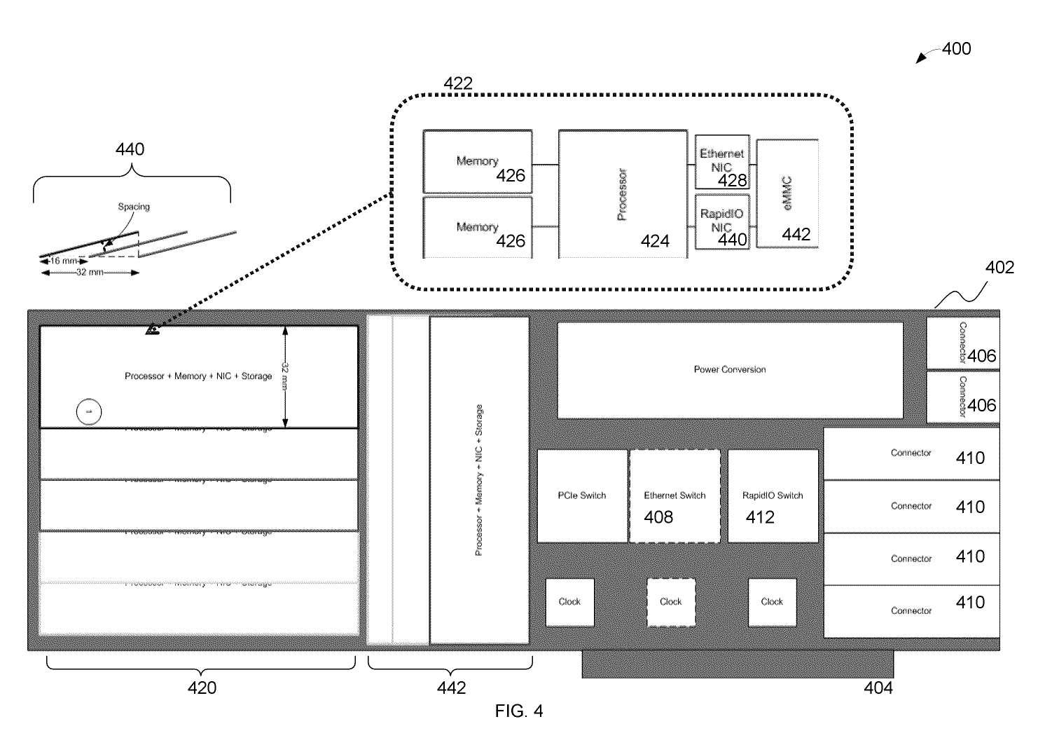

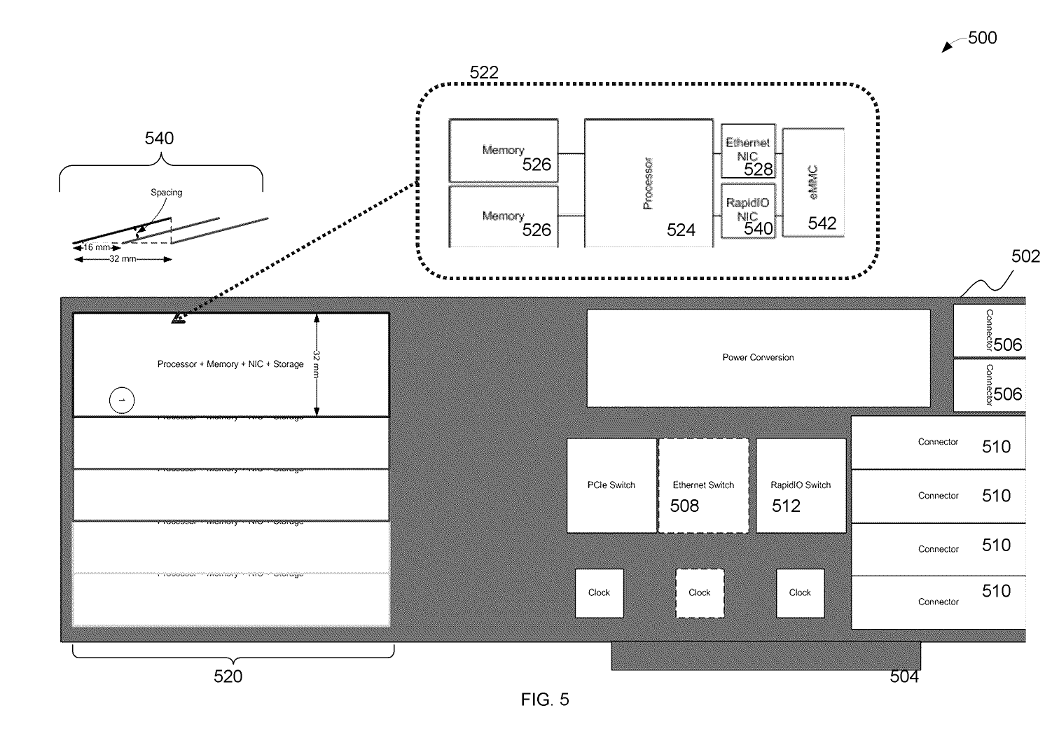

FIG. 3 illustrates, generally at 300, one embodiment of the invention showing a PCIe Network Analytics and Computing Card 302, which incorporates GPU+CPU computing with memory and storage. At 304 is a PCIe connector. At 306 are two connectors, for example Ethernet connectors, which are connected to an Ethernet Switch 308. At 310 are four connectors, for example RapidIO, which are connected to a RapidIO Switch 312. These 310 connectors can allow connection to other cards. At 320 are show micro-modules circled 1 \textcircled{1} through circled 8 \textcircled{8}, in this embodiment illustrating 8 micro-modules. Each micro-module is exemplified by 322 which shows more micro-module detail. At 324 is a processor (GPU+CPU) coupled to memory 326, coupled to an Ethernet NIC 328, and coupled to a RapidIO NIC 330. In this embodiment the Ethernet NIC 328 and RapidIO NIC 330 are coupled to the eMMC (embedded Multi Media Card) 332. At 320 is a top view of one of the micro-modules labeled circled 1 1 showing a width of 32 mm. Shown above PCIe Network Analytics and Computing Card 302 at 340 is a side view of the first three micro-modules from the left side of PCIe Network Analytics and Computing Card 302. As can be seen at 340 within a width of 32 mm, three micro-modules are mounted at an angle to the PCIe Network Analytics and Computing Card 302. In this way with spacing provided a higher density may be achieved on PCIe Network Analytics and Computing Card 302.

FIG. 4 illustrates, generally at 400, one embodiment of the invention showing a PCIe Network Analytics and Computing Card 402, which incorporates GPU+CPU computing with memory and storage. At 404 is a PCIe connector. At 406 are two connectors, for example Ethernet connectors, which are connected to an Ethernet Switch 408. At 410 are four connectors, for example RapidIO, which are connected to a RapidIO Switch 412. These 410 connectors can allow connection to other cards. At 420 are shown five micro-modules starting with circled 1 \textcircled{1} and arranged horizontally length-wise on the PCIe Network Analytics and Computing Card 402. At 442 are three micro-modules arranged vertically. Each micro-module is exemplified by 422 which shows more micro-module detail. At 424 is a processor (GPU+CPU) coupled to memory 426, coupled to an Ethernet NIC 428, and coupled to a RapidIO NIC 430. In this embodiment the Ethernet NIC 428 and RapidIO NIC 430 are coupled to the eMMC (embedded Multi Media Card) 432. At 420 is a top view of one of the micro-modules labeled circled 1 \textcircled{1} showing a width of 32 mm. Shown above PCIe Network Analytics and Computing Card 402 at 440 is a side view of the first three micro-modules viewed from the left side of PCIe Network Analytics and Computing Card 402. As can be seen at 440 within a width of 32 mm, three micro-modules are mounted at an angle to the PCIe Network Analytics and Computing Card 402. In this way with spacing provided a higher density may be achieved on PCIe Network Analytics and Computing Card 402. This same spacing at 440 can be applied to the three vertically oriented micro-modules at 442.

FIG. 5 illustrates, generally at 500, one embodiment of the invention showing a PCIe Network Analytics and Computing Card 502, which incorporates GPU+CPU computing with memory and storage. At 504 is a PCIe connector. At 506 are two connectors, for example Ethernet connectors, which are connected to an Ethernet Switch 508. At 510 are four connectors, for example RapidIO, which are connected to a RapidIO Switch 512. These 510 connectors can allow connection to other cards. At 520 are shown five micro-modules starting with circled 1 \textcircled{1} and arranged horizontally length-wise on the PCIe Network Analytics and Computing Card 502. Each micro-module is exemplified by 522 which shows more micro-module detail. At 524 is a processor (GPU+CPU) coupled to memory 526, coupled to an Ethernet NIC 528, and coupled to a RapidIO NIC 530. In this embodiment the Ethernet NIC 528 and RapidIO NIC 530 are coupled to the eMMC (embedded Multi Media Card) 532. At 520 is a top view of one of the micro-modules labeled circled 1 \textcircled{1} showing a width of 32 mm. Shown above PCIe Network Analytics and Computing Card 502 at 540 is a side view of the first three micro-modules viewed from the left side of PCIe Network Analytics and Computing Card 502. As can be seen at 540 within a width of 32 mm, three micro-modules are mounted at an angle to the PCIe Network Analytics and Computing Card 502. The spacing from micro-module to micro-module is 16 mm. In this way by mounting at an angle a higher density may be achieved on PCIe Network Analytics and Computing Card 502.

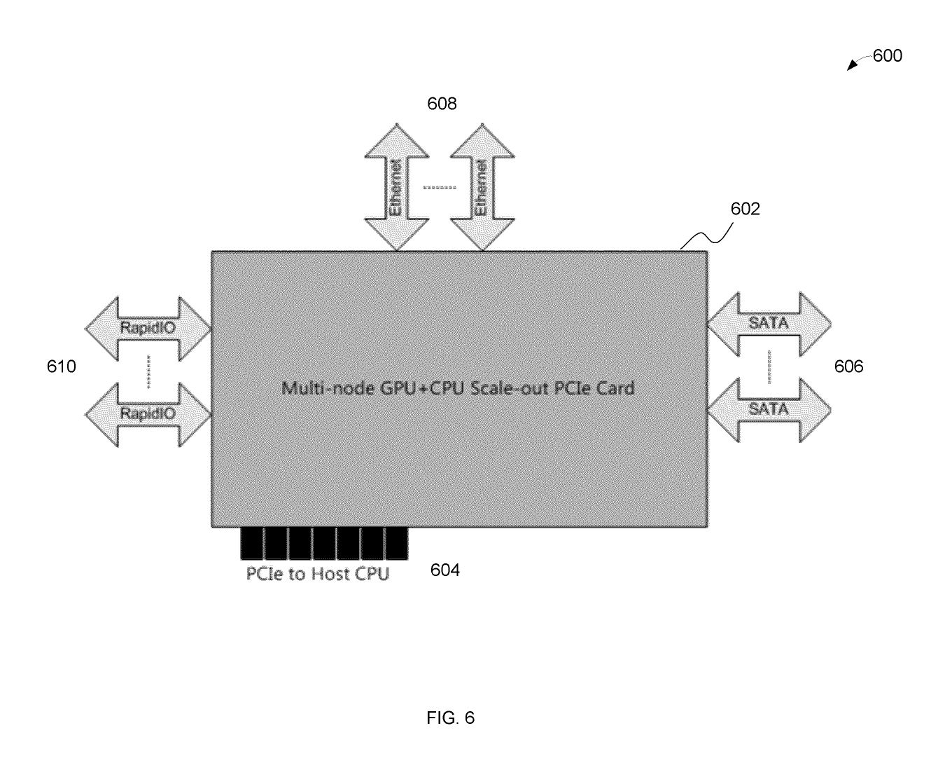

FIG. 6 illustrates, generally at 600, one embodiment of the invention showing a PCIe card 602, with SATA storage interface 606, a PCIe 604 host interface to connect to a host server board, Ethernet for network connection 608, and RapidIO 610 for inter-card scalability and low latency data distribution. In this embodiment, the SATA 606 can connect to storage that is not located on the PCIe card 602.

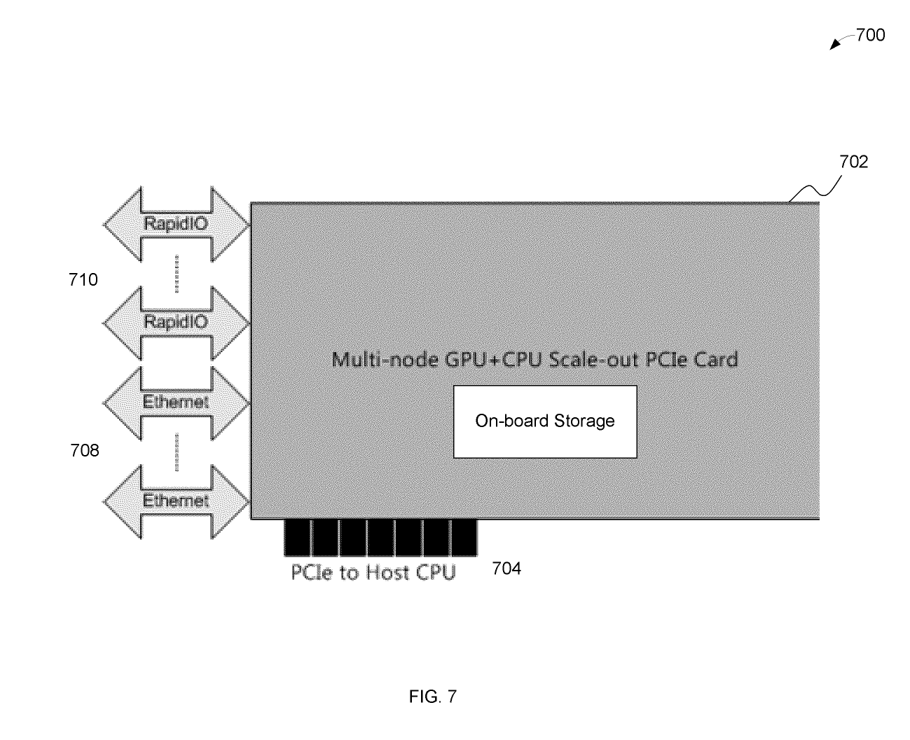

FIG. 7 illustrates, generally at 700, one embodiment of the invention showing a PCIe card 702 with on-board storage, a PCIe 704 host interface to connect to a host server board, Ethernet 708 for network connection, and RapidIO 710 for inter-card scalability and low latency data distribution.

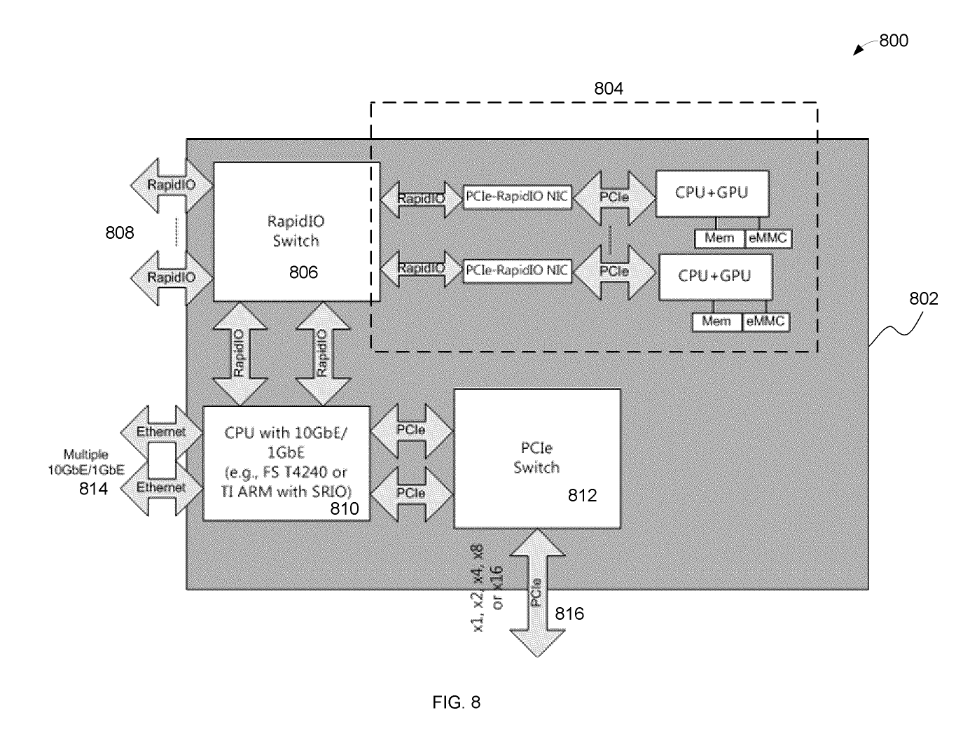

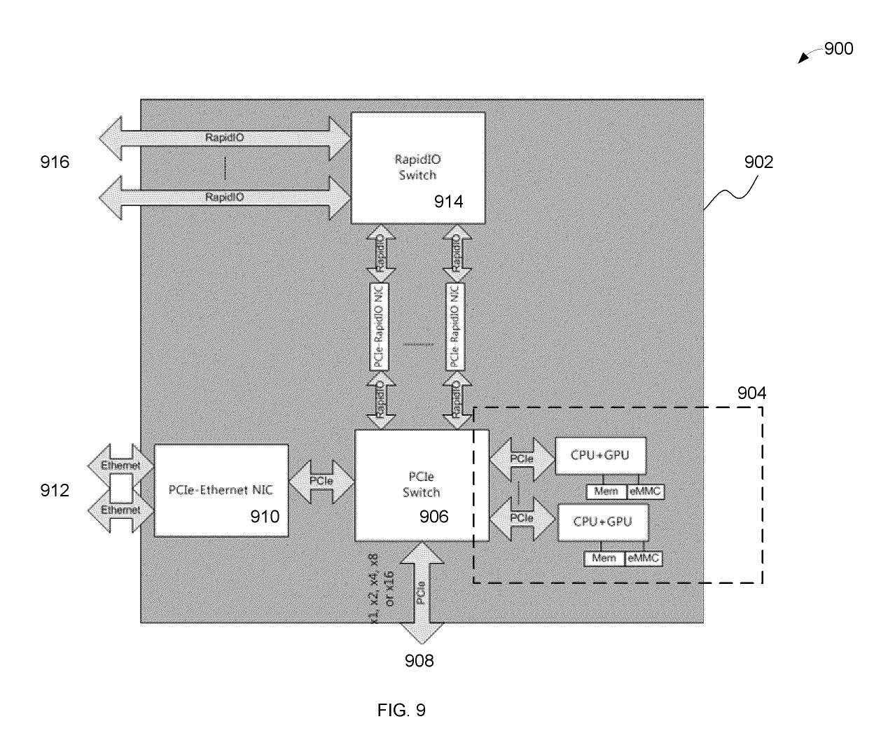

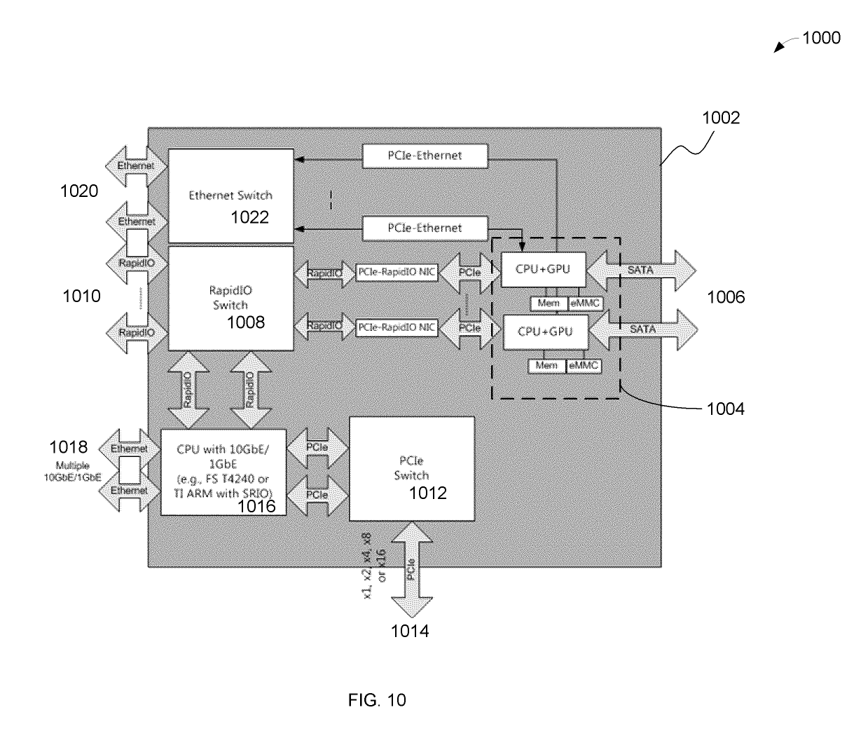

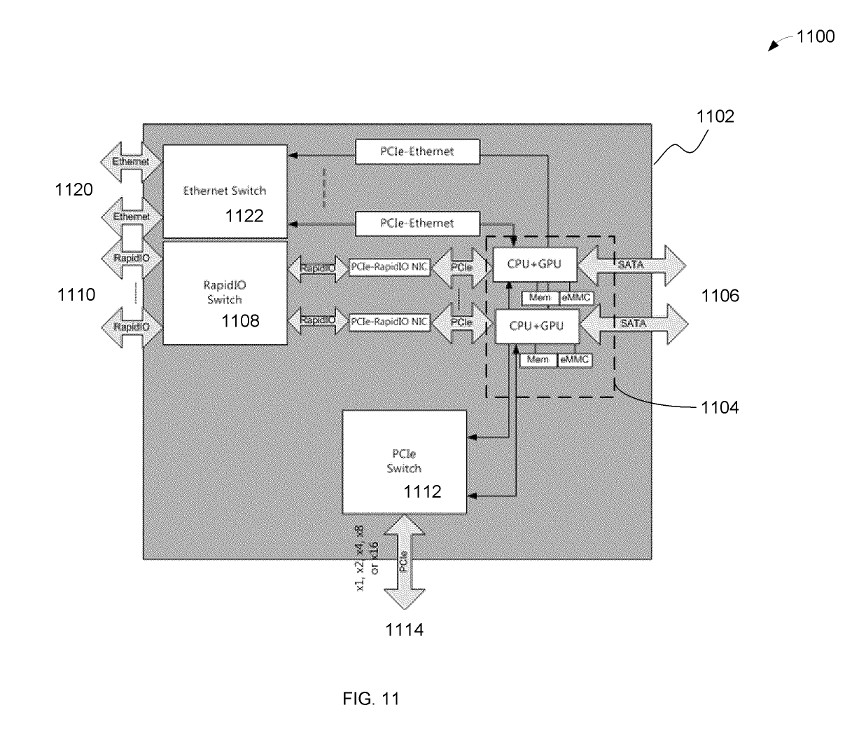

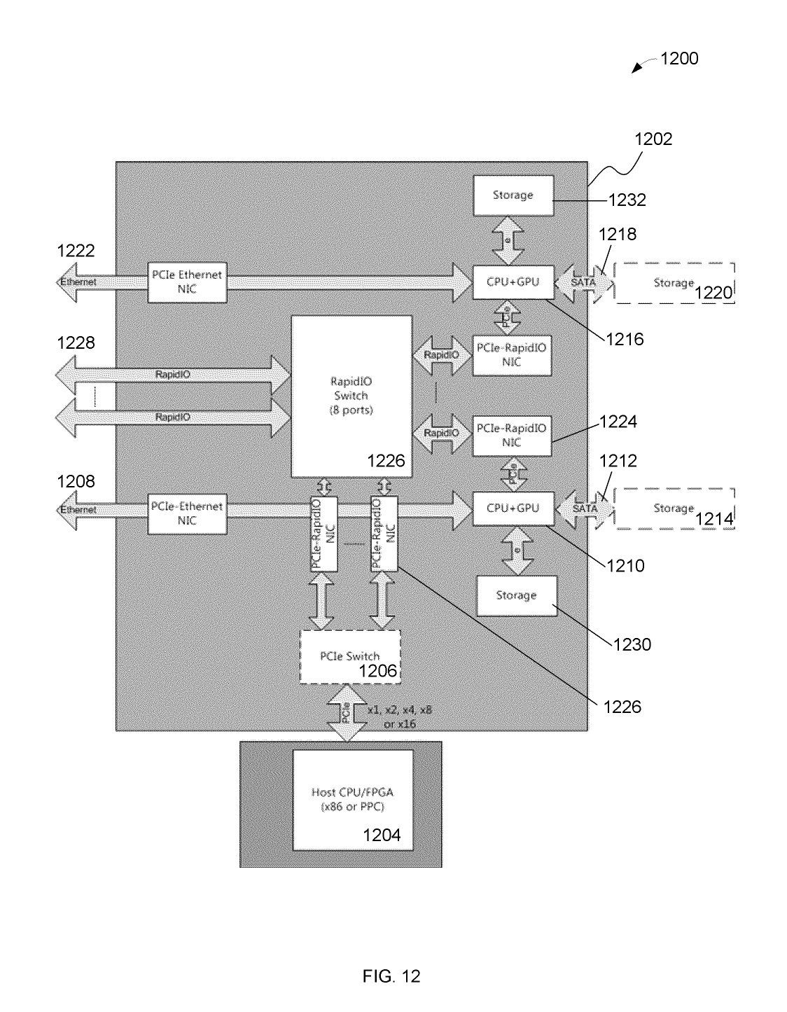

FIG. 8 illustrates, generally at 800, one embodiment of the invention showing a network analytics and computing card 802. At 804 are multiple CPU+GPU each connected to memory and eMMC and communicating via PCIe-RapidIO NIC to RapidIO to a RapidIO switch 806. RapidIO switch 806 connects to multiple RapidIO ports 808, and via multiple RapidIO links to a CPU 810 with multiple Ethernet 814 interfaces. CPU 810 is also connected to multiple PCIe buses to PCIe switch 812 which interfaces to a PCIe bus 816. The network analytics and computing card incorporates a PCIe switch to interconnect multiple CPU+GPU and PCIe-to-Ethernet NIC. The PCIe switch needs limited multi-root connection, RapidIO and PCIe-RapidIO provides connection directly to CPU+GPU and scales across cards with multi-root connectivity. The RapidIO switch is used to scale across multiple cards. The CPU with 10 GbE provides network connectivity while providing hardware off-loads for various network functions.

FIG. 9 illustrates, generally at 900, one embodiment of the invention showing a network analytics and computing card 902. At 904 are multiple CPU+GPU each connected to memory and eMMC and communicating via PCIe to a PCIe Switch 906. PCIe Switch 906 connects via PCIe to PCIe-Ethernet NIC 910 to multiple Ethernet ports 912. PCIe Switch 906 also connects via multiple RapidIO and PCIe-RapidIO NIC to RapidIO Switch 914. RapidIO Switch 914 also connects to multiple RapidIO links 916. In this illustrated embodiment, the network analytics and computing card incorporates a PCIe switch to interconnect multiple CPU+GPU and PCIe-to-Ethernet NIC. PCIe NTB (non-transparent bridging) switches are needed for on-board multi-root connection. RapidIO and PCIe-RapidIO provides multi-root connection across cards. A RapidIO switch is used to scale across multiple cards and distribute traffic.

FIG. 10 illustrates, generally at 1000, one embodiment of the invention showing a network analytics and computing card 1002. At 1004 are multiple CPU+GPU each connected to memory and eMMC and communicating via a SATA port 1006, and via PCIe to PCIe-RapidIO NIC then through RapidIO to RapidIO Switch 1008. RapidIO Switch 1008 communicates with RapidIO links 1010, and via RapidIO links to CPU with Ethernet 1016 (CPU Block). CPU with Ethernet 1016 communicates via PCIe with PCIe Switch 1012 that communicates via PCIe 1014. CPU with Ethernet 1016 also communicates via Ethernet 1018. Multiple CPU+GPU 1004 also communicates with PCIe-Ethernet to Ethernet Switch 1022 which communicates with Ethernet 1020. Ethernet 1020 is for communications with one or more devices not located on network analytics and computing card 1002. In this illustrated embodiment there is incorporated a SATA link for external storage using SATA interface 1006 from multiple CPU+GPU 1004, it also incorporates an Ethernet switch 1022 for network traffic load distribution.

FIG. 11 illustrates, generally at 1100, one embodiment of the invention showing a network analytics and computing card 1102. At 1104 are multiple CPU+GPU each connected to memory and eMMC and communicating via a SATA port 1106, and via PCIe to PCIe-RapidIO NIC then through RapidIO to RapidIO Switch 1108. RapidIO Switch 1108 communicates with RapidIO 1110. CPU+GPU 1104 communicate with PCIe Switch 1112 that communicates via PCIe 1114. CPU+GPU 1104 also communicates via PCIe-Ethernet to Ethernet Switch 1122 which communicates with Ethernet 1120. In this illustrated embodiment there is incorporated a SATA link 1106 for external storage using SATA interface from CPU+GPU. This embodiment also incorporates an Ethernet switch 1122 for network traffic load distribution. This allows direct communication between CPU+GPU 1104 and host server board (via 1114) through PCIe switch 1112. A small port count PCIe switch 1112 needs a small number of multi-root ports for on-board connection. The RapidIO 1110 allows traffic distribution and low latency links between other network analytics and computing cards.

FIG. 12 illustrates, generally at 1200, one embodiment of the invention showing a network processing card 1202. At 1204 is a Host. At 1206 is an optional PCIe Switch. At 1208 is an Ethernet interface that communicates with CPU+GPU at 1210. At 1212 is an optional SATA interface connected to an optional external Storage 1214. At 1216 is another CPU+GPU which can communicate via with Ethernet port 1222. At 1218 is an optional SATA interface. At 1220 is optional external Storage (i.e. Storage 1220 not located on network processing card 1202. At 1224 is a PCIe-RapidIO NIC and at 1226 is a RapidIO Switch. At 1230 and 1232 are on-board Storage connected respectively to CPU+GPU 1210 and 1216. Storage 1230 and 1232 can be any combination of, for example, memory, eMMC, etc.

In one embodiment, for example, as illustrated in FIG. 12, a RapidIO Direct connection with the GPU is used. For example, data and control information can be exchanged between the Host CPU/FPGA 1204 and GPU 1210 through PCIe-RapidIO NIC 1224 and RapidIO Switch 1226.

In one embodiment, for example, as illustrated in FIG. 12, the PCIe switch 1206 is optional, that is it could be removed, and in this case, the PCIe-RapidIO NICs 1226 are directly connected to the Host CPU/FPGA 1204.

In one embodiment, for example, as illustrated in FIG. 12, the PCIe port in the Host CPU 1204 is bi-furcated, that is a 8× port can be used as two 4× ports.

In one embodiment, for example, as illustrated in FIG. 12, a CPU+GPU 1210 can communicate directly via Ethernet 1208. The CPU+GPU 1210 can also communicate to other cards via RapidIO 1228 through 1226 and 1224. The CPU+GPU 1210 can also communicate to the Host 1204 via RapidIO from 1224 through 1226 and without the PCIe Switch 1206 which is optional to the Host 1204.

In one embodiment, for example, as illustrated in FIG. 12, without the optional features an overall solution is less complex as there are a fewer number of devices that need to be managed.

Thus Methods and Apparatus for Efficient Network Analytics and Computing Card has been described.

Because of the high speed embodiments the present invention requires specialized hardware.

As used in this description “GPU” or similar phrases, such as “Graphics Processing Unit” refers to specialized hardware that is not to be confused with a CPU (central processing unit). One skilled in the art understands that a GPU and CPU are different. For example, but not limited to, a GPU generally has specialized hardware for the efficient processing of pixels and polygons (image processing).

As used in this description “GPU+CPU” or “CPU+GPU” or “CPU/GPU” or similar phrases refers to a CPU and GPU combination. That is, a CPU and GPU are both present in the embodiment and in close physical and electrical proximity. The CPU+GPU may be a combination of a CPU on a different integrated circuit than the GPU, or the CPU+GPU combination may be on a single integrated circuit.

As used in this description “host processor” or similar phrases refers to a CPU and not a GPU.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as “substantially equal” is used to indicate that they are for all practical purposes equal.

It is to be understood that in any one or more embodiments of the invention where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus Methods and Apparatus for Efficient Network Analytics and Computing Card have been described.

What is claimed is:

1. A method for providing a network analytics and computing card comprising:
mounting on a micro-module one or more GPUs each having an integrated CPU;
mounting on said micro-module memory and storage accessible by said one or more GPUs; and
mounting on a PCIe card one or more angled connectors capable of connecting said micro-module to circuitry mounted on said PCIe card.

2. The method of claim 1 wherein said angled connectors hold said micro-module at an angle of between 10 degrees and 80 degrees when measured with respect to the surface plane of said PCIe card wherein normal to said surface plane of said PCIe card is defined as 90 degrees and parallel to said surface plane of said PCIe card is defined as 0 degrees.

3. The method of claim 2 further comprising connecting two or more of said micro-modules on said PCIe card via two or more of said one or more angled connectors.

4. The method of claim 3 wherein said micro-modules are in communication with an Ethernet switch mounted on said PCIe card.

5. The method of claim 4 wherein said micro-modules are in communication with a RapidIO switch mounted on said PCIe card.

6. The method of claim 5 wherein a plurality of PCIe cards according to claim 1 are interconnected via a connector on each of said plurality of PCIe cards via RapidIO.

7. A network analytics and computing card comprising:
two or more CPU+GPU modules each connected to memory and eMMC; and
said two or more CPU+GPU modules each also connected via PCIe-RapidIO NIC to a RapidIO switch.

8. The network analytics and computing card of claim 7 wherein said RapidIO switch is connected to two or more RapidIO ports for communications to components off of said network analytics and computing card and to two or more RapidIO ports for communication to components on said network analytics and computing card.

9. The network analytics and computing card of claim 8 further comprising:
a CPU block, said CPU block having a CPU with multiple Ethernet interfaces, said CPU block having a set of RapidIO interfaces and a set of PCIe interfaces;
a PCIe switch having a first and second set of PCIe interfaces; and
wherein said CPU block set of RapidIO interfaces are connected to said RapidIO switch two or more RapidIO ports, wherein said CPU block set of PCIe interfaces are connected to said PCIe switch first set of PCIe interfaces, wherein said PCIe switch second set of PCIe interfaces for communications to a host computer not located on said network analytics and computing card.

10. The network analytics and computing card of claim 9 further comprising two or more SATA ports, each of said two or more SATA ports connected to a single one of each of said two or more CPU+GPU modules, said two or more SATA ports connected to a storage device not located on said network analytics and computing card.

11. The network analytics and computing card of claim 10 further comprising:
two or more PCIe-Ethernet ports, each of said two or more PCIe-Ethernet ports connected to one or more of said two or more CPU+GPU modules, said two or more PCIe-Ethernet ports connected to a Ethernet switch, said Ethernet switch connected to one or more Ethernet ports for communication with one or more devices not located on said network analytics and computing card.

12. The network analytics and computing card of claim 8 wherein one or more of said two or more PCIe ports for communication to components is connected via an entity to a PCIe connector on said network analytics and computing card for connection to a host computer not located on said network analytics and computing card, wherein said entity is selected from the group consisting of a direct connection, and a PCIe switch.

13. An apparatus comprising:
a micro-module PCB (printed circuit board) substantially having a size form factor similar to a DIMM (Dual Inline Memory Module);
a GPU (Graphics Processing Unit) mounted on said micro-module PCB;
a CPU (Central Processing Unit) mounted on said micro-module PCB;
a memory mounted on said micro-module PCB;
a flash storage mounted on said micro-module PCB;
an Ethernet NIC (Network Interface Controller) mounted on said micro-module PCB;
a RapidIO NIC mounted on said micro-module PCB; and
wherein said GPU and CPU are connected to said memory, said flash storage, said Ethernet NIC, said RapidIO NIC, and to connections on said micro-module PCB.

14. The apparatus of claim 13 further comprising:
a network analytics and computing PCB card having thereon a PCIe (Peripheral Component Interconnect Express) connector, an Ethernet switch mounted on said network analytics and computing PCB card, a RapidIO switch mounted on said network analytics and computing PCB card, one or more Ethernet connectors mounted on said network analytics and computing PCB card, one or more RapidIO connectors mounted on said network analytics and computing PCB card, one or more micro-module connectors mounted on said network analytics and computing PCB card;
wherein said micro-module PCB is connected to said one or more micro-module connectors;
wherein said micro-module PCB connections make electrical connection with a plurality of traces on said network analytics and computing PCB card;
wherein said micro-module PCB Ethernet NIC makes connection with said network analytics and computing PCB card Ethernet switch;
wherein said micro-module PCB RapidIO NIC makes connection with said network analytics and computing PCB card RapidIO switch;
wherein said network analytics and computing PCB card Ethernet switch connects to one or more of said one or more Ethernet connectors mounted on said network analytics and computing PCB card; and
wherein said network analytics and computing PCB card RapidIO switch connects to one or more of said one or more RapidIO connectors mounted on said network analytics and computing PCB card.

15. The apparatus of claim 14 wherein said RapidIO connectors mounted on said network analytics and computing PCB card are used to connected to another network analytics and computing PCB card.

16. The apparatus of claim 14 further comprising a plurality of said micro-module PCBs connected to said one or more micro-module connectors mounted on said network analytics and computing PCB card.

17. The apparatus of claim 16 wherein each of said plurality of said micro-module PCBs are connected to said network analytics and computing PCB card Ethernet switch.

18. The apparatus of claim 16 wherein each of said plurality of said micro-module PCBs are connected to said network analytics and computing PCB card RapidIO switch.

19. The apparatus of claim 17 wherein each of said plurality of said micro-module PCBs are connected to said network analytics and computing PCB card RapidIO switch.

20. The apparatus of claim 14 further comprising a PCIe switch mounted on said network analytics and computing PCB card and wherein said PCIe connector is connected to said PCIe switch.
